(19) United States
(12) Patent Application Publication
(10) Pub. No.: US 2025/0250026 A1
(43) Pub. Date: Aug. 7, 2025

(54) Tailored Fuel Calculations

(71) Applicant: The Boeing Company, Arlington, VA (US)

(72) Inventors: Timothy Michael Wilky, Frisco, TX (US); Robert A. Schultz, Kent, WA (US)

(21) Appl. No.: 18/434,311

(22) Filed: Feb. 6, 2024

(51) Int. Cl. B64D 45/00

(52) U.S. Cl. CPC B64D 45/00; B64D 2045/0075

(57) ABSTRACT

Generating tailored fuel and weight calculations is provided. The method comprises receiving input of a configuration file that defines a customized formula for fuel and weight calculations for an aircraft mission, wherein the formula references base category values in an electronic flight folder. The configuration file is loaded into an electronic flight bag application on a mobile device. The electronic flight bag application interpreted the customized formula in the configuration file to calculate tailored fuel and weight for the aircraft mission.

### BACKGROUND INFORMATION

### Technical Field

The present disclosure relates generally to aircraft fuel and weight calculations for flight plans, and more specifically to providing customizable fuel and weight calculations.

### BACKGROUND

Airlines need to display specific fuel and weight calculations to their pilots that are based on the addition/subtraction of multiple fuel/weight values in the ARINC® 633 Flight Plan XML, for example, minimum required takeoff fuel. These values exist on legacy paper flight plans but are not authored in the digital version of the flight plan.

### SUMMARY

An illustrative embodiment provides a computer-implemented method of generating tailored fuel and weight calculations. The method comprises receiving input of a configuration file that defines a customized formula for fuel and weight calculations for an aircraft mission, wherein the formula references base category values in an electronic flight folder. The configuration file is loaded into an electronic flight bag application on a mobile device. The electronic flight bag application interpreted the customized formula in the configuration file to calculate tailored fuel and weight for the aircraft mission.

Another illustrative embodiment provides a system for generating tailored fuel and weight calculations. The system comprises a storage device that stores program instructions and one or more processors operably connected to the storage device and configured to execute the program instructions to cause the system to: receive input of a configuration file that defines a customized formula for fuel and weight calculations for an aircraft mission, wherein the formula references base category values in an electronic flight folder; load the configuration file into an electronic flight bag application on a mobile device; and interpret, by the electronic flight bag application, the customized formula in the configuration file to calculate tailored fuel and weight for the aircraft mission.

Another illustrative embodiment provides a computer program product for generating tailored fuel and weight calculations. The computer program product comprises a computer-readable storage medium having program instructions embodied thereon to perform the steps of: receiving input of a configuration file that defines a customized formula for fuel and weight calculations for an aircraft mission, wherein the formula references base category values in an electronic flight folder; loading the configuration file into an electronic flight bag application on a mobile device; and interpreting, by the electronic flight bag application, the customized formula in the configuration file to calculate tailored fuel and weight for the aircraft mission.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a diagram illustrating the operation of an electronic flight bag system in which the illustrative embodiments can be employed;

FIG. 2 depicts a block diagram of a tailored fuel calculation system in accordance with an illustrative embodiment;

FIG. 3 depicts a pictorial diagram illustrating a user interface displaying a tailored fuel calculation in accordance with an illustrative embodiment;

FIG. 4 depicts an example XML schema for providing custom calculation of additional fuel in accordance with an illustrative embodiment;

FIG. 5 depicts an example XML schema for providing custom calculation of alternate fuel in accordance with an illustrative embodiment;

FIG. 6 depicts a flowchart illustrating a process for generating tailored fuel and weight calculations in accordance with an illustrative embodiment; and

FIG. 7 is an illustration of a block diagram of a data processing system in accordance with an illustrative embodiment.

### DETAILED DESCRIPTION

The illustrative embodiments recognize and take into account that the airlines need to display specific fuel and weight calculations to their pilots that are based on the addition/subtraction of multiple fuel/weight values in the ARINC® (Aeronautical Radio, Incorporated) 633 Flight Plan XML, for example, minimum required takeoff fuel. These values exist on legacy paper flight plans but are not authored in the digital version of the flight plan.

The illustrative embodiments also recognize and take into account that displaying these custom calculated fuel and weight values required one-off development work for each customer's requirements.

The illustrative embodiments provide a method to calculate custom fuel durations, fuel amounts, and aircraft weight amounts from base fuel and weight figures defined in an XML (Extensible Markup Language) operational flight plan document contained in an ARINC® Specification 633 Electronic Flight Folder. The method comprises defining custom fuel and weight calculation formulas in an XML configuration file utilizing a novel syntax that identifies unique XML elements by name, location, relative position, and variable “reason” and “airportFunction” string attributes defined in ARINC® Specification 633.

A tablet computer application then sequentially evaluates the terms of the formulas constructed from the unique identifiers and their qualifiers, matching them against one or more values within the operational flight plan XML to calculate a final result. Each formula is identified by a unique identifier which is matched against identifiers for customer-defined label text and sequence within the configurable XML file to display the final values in the appropriate sections of a user interface.

The illustrative embodiments permit airlines to revise their fuel and weight calculations on demand in response to any changes in regulatory requirements without any additional development work required in the application. Instead of requiring customers to use XML Path Language (XPath) to define the values to retrieve from the XML, the illustrative embodiments provide a simple syntax that is human readable and can be used by anybody, with or without technical expertise, to define and modify an airline's fuel and weight formulas. Therefore, the illustrative embodiments provide the technical benefit of simplicity and ease of use for non-expert users.

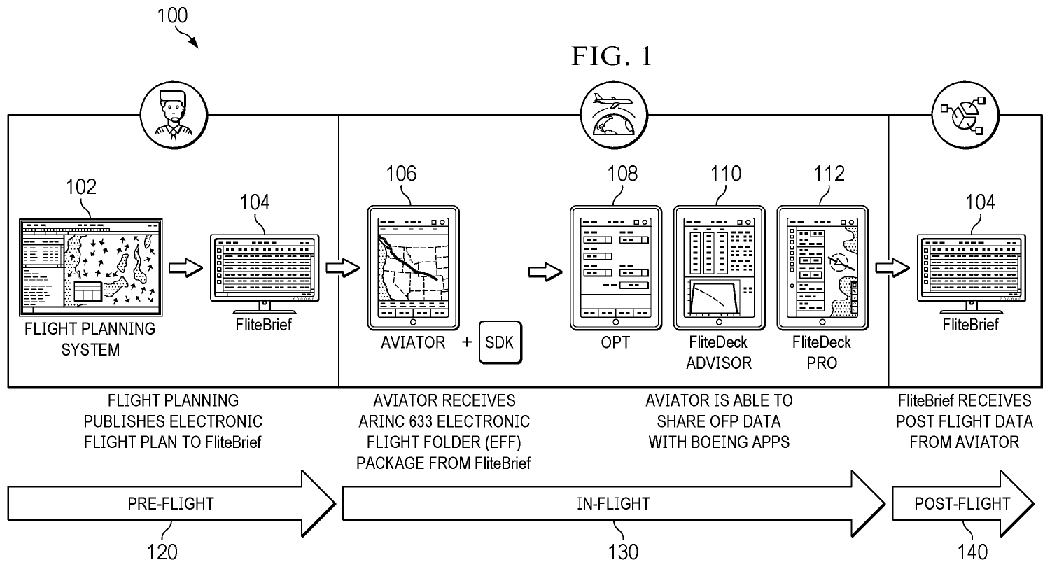

FIG. 1 depicts a diagram illustrating the operation of an electronic flight bag system in which the illustrative embodiments can be employed. The functional elements of electronic flight bag system 100 can be divided into pre-flight 120, in-flight 130, and post-flight 140 phases.

In the pre-flight phase 120 a flight planning system 102 publishes flight plan data to a crew briefing and flight monitoring application 104 such as FliteBrief by Jeppesen®.

During the in-flight phase 130, an electronic flight bag (EFB) application 106 such as Aviator by Jeppesen® receives ARINC® 633 electronic flight folder (EFF) packages from the crew briefing and flight monitoring application 104. The EFB application 106 may be deployed on a tablet computer and is able to share operational flight plan (OFP) data with other onboard applications deployed on the tablet computer such as, e.g., Boeing Onboard Performance Tool (OPT) 108, flight optimization application 110 (e.g., FliteDeck Advisor), and airline charting application 112 (e.g., FliteDeck Pro). A pilot can enter information into EFB application 106 during a flight such as time of takeoff, and other events and data pertinent to the flight.

During the post-flight phase 140 the EFB application 106 provides post-flight data such as data entered by the pilot to crew briefing and flight monitoring application 104.

The customizable fuel and weight calculation capabilities provided by the illustrative embodiments are displayed in the EFB application 106 as part of the electronic flight folder according to the ARINC® 633 standard.

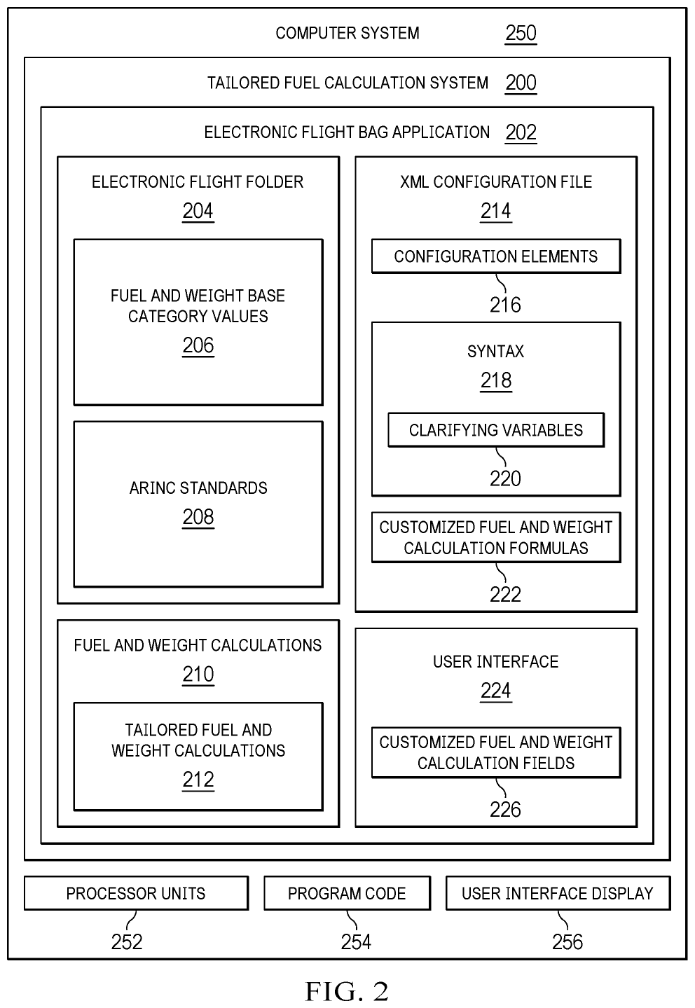

FIG. 2 is a block diagram of a tailored fuel calculation system depicted in accordance with an illustrative embodiment. Tailored fuel calculation system 200 provides the ability to specify customized fuel and weight calculations 222 for aircraft missions for use in an electronic flight bag application 202. Tailored fuel calculation system 200 is implemented on a computer system 250 which might comprise a table computer for use onboard an aircraft.

Electronic flight bag application 202 includes an electronic flight folder 204 which contains a number of fuel and weight base category values 206. These category values comply with ARINC® 633 standards 208. The electronic flight bag application is able to generate fuel and weight calculations 210 according to the fuel and weight base category values 206.

An XML configuration file 214 provides a syntax 218 that allows customers to enter clarifying variables 220. These clarifying variables 220 are applied to a number of configuration elements 216 that correspond to the fuel and weight base category values 206, which allows a customer to refine the base category values to create customized fuel and weight calculation formulas 222.

The syntax 218 allows an airline to refer to any of the 26 fuel/weight elements defined in the ARINC® 633 specification and further clarify these variables by specifying clarifying aspects, such as their relative position in the XML—for example, the third alternate airport listed, look for an unlimited number of free-text reason codes authored by the flight planning system, and airport function codes enumerated in the ARINC® specification. There is no limit to the number of variables an airline can use in the formula.

From the customized fuel and weight calculation formulas 222 the electronic flight bag application 202 is able to determine tailored fuel and weight calculations 212. These tailored fuel and weight calculations 212 can be displayed in customized fuel and weight calculation fields 226 in user interface 224. Tailored fuel calculation system 200 can also notify ground crew personnel to add fuel according to the tailored fuel and weight calculations 212 for aircraft missions. This notification can be presented to the ground crew via an interface similar to user interface 224 or through a different specialized user interface.

User interface 224 is shown in user interface display 256. User interface display 256 is a physical hardware system and includes one or more display devices on which a user interface such as user interface 224 can be displayed. The display devices in user interface display 256 can include at least one of a light emitting diode (LED) display, a liquid crystal display (LCD), an organic light emitting diode (OLED) display, a computer monitor, a projector, a flat panel display, a heads-up display (HUD), a head-mounted display (HMD), or some other suitable device that can output information for the visual presentation of information.

Tailored fuel calculation system 200 can be implemented in software, hardware, firmware, or a combination thereof. When software is used, the operations performed by tailored fuel calculation system 200 can be implemented in program code configured to run on hardware, such as a processor unit. When firmware is used, the operations performed by tailored fuel calculation system 200 can be implemented in program code and data and stored in persistent memory to run on a processor unit. When hardware is employed, the hardware can include circuits that operate to perform the operations in tailored fuel calculation system 200.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 250 is a physical hardware system and includes one or more data processing systems. When more than one data processing system is present in computer system 250, those data processing systems are in communication with each other using a communications medium. The communications medium can be a network. The data processing systems can be selected from at least one of a computer, a server computer, a mobile device such as a tablet computer, or some other suitable data processing system.

As depicted, computer system 250 includes a number of processor units 252 that are capable of executing program code 254 implementing processes in the illustrative examples. As used herein, a processor unit in the number of processor units 252 is a hardware device and is comprised of hardware circuits such as those on an integrated circuit that respond and process instructions and program code that operate a computer. When a number of processor units 252 execute program code 254 for a process, the number of processor units 252 is one or more processor units that can be on the same computer or on different computers. In other words, the process can be distributed between processor units on the same or different computers in a computer system. Further, the number of processor units 252 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

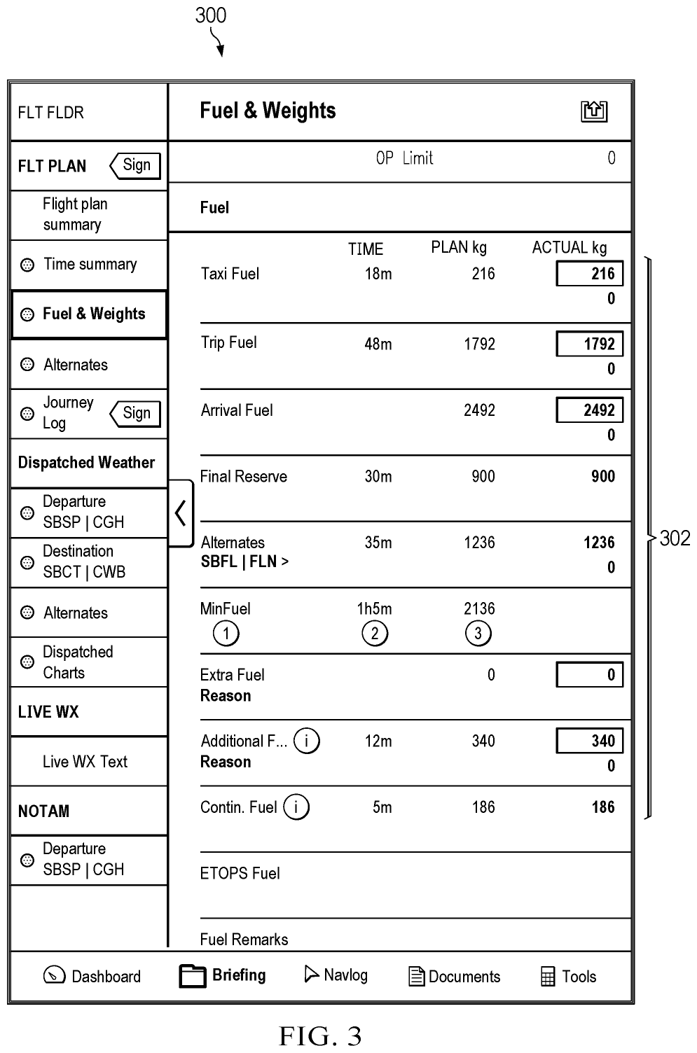

FIG. 3 depicts a pictorial diagram illustrating a user interface displaying a tailored fuel calculation in accordance with an illustrative embodiment. User interface 300 is an example of user interface 224 in FIG. 2.

User interface 300 illustrates an example of defining a new ConfigElement name ‘FWCustomField01’ and associating it to a complimentary layoutElement ‘FWCustomField01’ under the LayoutGroup named ‘FuelWeightsLayout’.

A tailored calculation follows the tabular format of user interface 300. This format includes user interface label, duration calculation, and weight calculation. An administrator can add tailored calculations as LayoutElements within the sections of the Fuel and Weights Page that include FuelWeightsSummary, Fuel, and Weights.

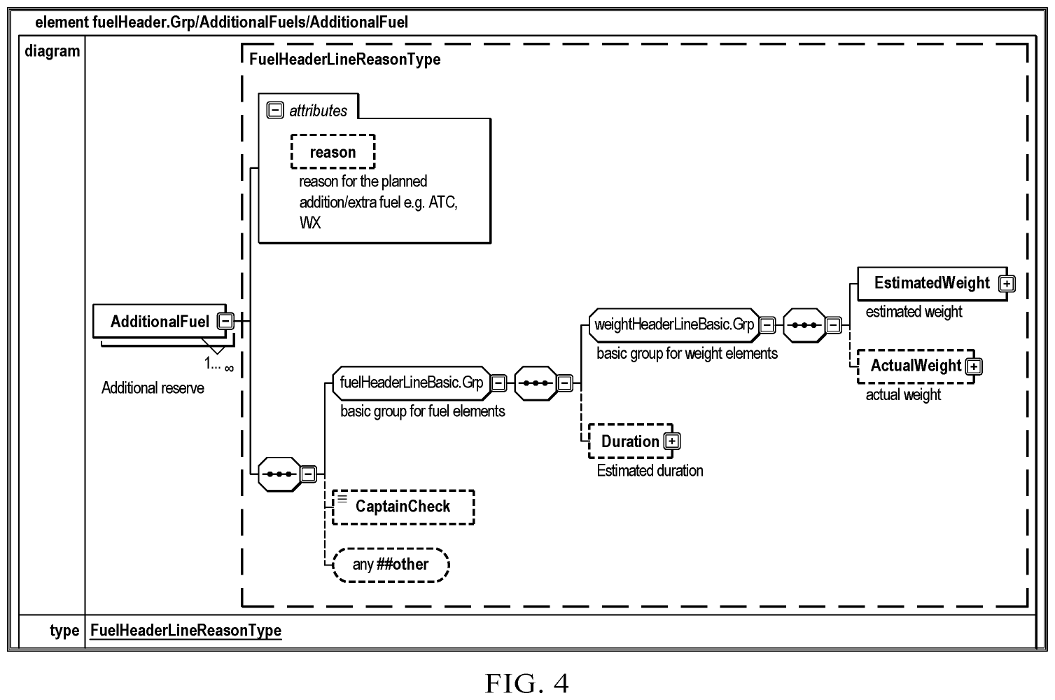

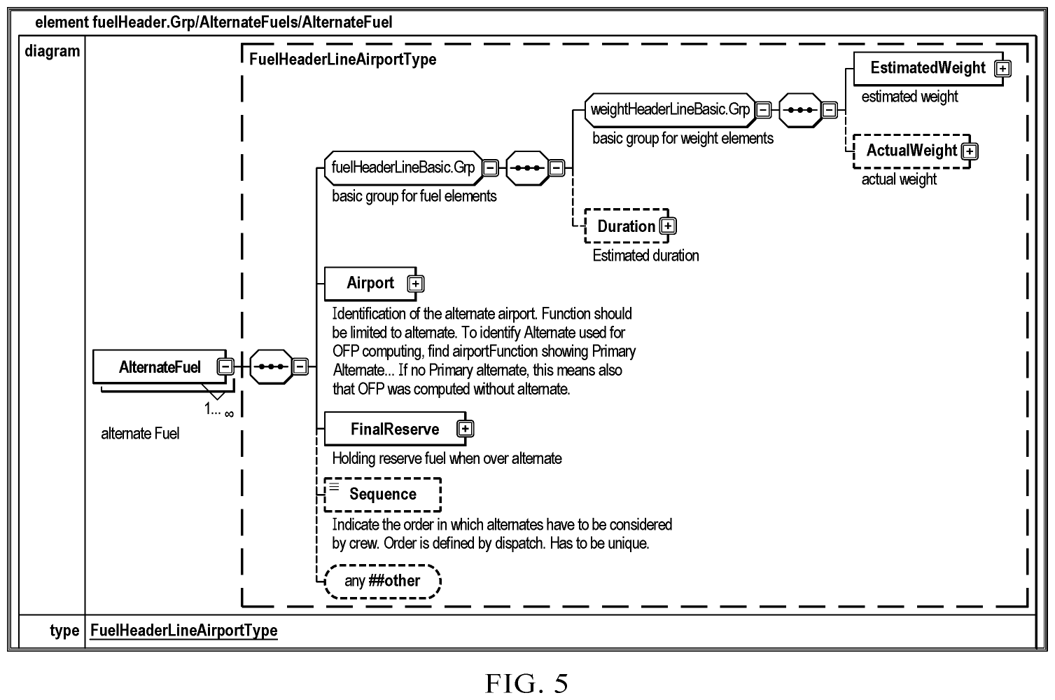

FIGS. 4 and 5 illustrate XML schema that can be used to implement a customizable XML configuration file such as XML configuration file 214 in FIG. 2.

FIG. 4 depicts an example XML schema for providing custom calculation of additional fuel in accordance with an illustrative embodiment. AdditionalFuel is one of the categories standardized in the ARINC® 633 Specification. This schema allows customer calculations for both weight and duration.

The XML syntax provides a set of rules that allow customers to flexibly specify different versions of the category AdditionalFuel according to the customers' specific needs. AdditionalFuel is the parent of a number of potential values. Therefore, if AdditionalFuel is specified, it will return the sum of all AdditionalFuel/EstimatedWeight values. By adding brackets and index values, customers can refine the calculations. For example, by using AdditionalDuel[reason=‘DispatchDefined’] will retrieve the estimate weight and duration value for the additional fuel of reason=‘DispatchDefined’. If the value does not exist, then the value is 0.

As another example, AdditionalFuel[0] will retrieve the estimated weight for the First Additional Fuel value provided by the Flight Plan Provider (FPP) within the Operational Flight Plan (OFP.xml) if it extists. Otherwise, the value is 0. For duration value, AdditionalFuel[0] retrieves the duration value for the first AdditionalFuel if it exists. Otherwise, the value is 0.

AdditionalFuel[1] will retrieve the fuel weight for the Second Additional Fuel value provided by the FPP within the OFP.xml if it exists. Otherwise, the value is 0. AdditionalFuel[1] will retrieve the duration value for second AdditionalFuel if it exists. Otherwise, the value is 0.

AdditionalFuel[reason=″ ] retrieves the estimated weight for the first additional fuel that has no reason attribute OR the reason value=″″.

FIG. 5 depicts an example XML schema for providing custom calculation of alternate fuel in accordance with an illustrative embodiment. AlternateFuel is also one of the categories standardized in the ARINC® 633 Specification. This schema allows customer calculations for both weight and duration.

In this example, the parent value AlternateFuel will return the sum of all AlternateFuel/EstimatedWeight values or AlternateFuel/Duration values.

AlternateFuel[airportFunction=‘PrimaryArrivalAl ternateAirport’] will return the first AlternateFuel that matches the airportFunction value. If this value does not exist, it will return 0.

Similar to the example in FIG. 4, the syntax format AlternateFuel[i] allows a descending list of options. For example, AlternateFuel[1] retrieves the first AlternateFuel/EsitmateWeight value or AlternateFuel/Duration value within the AlternateFuel list of it exists. If the list does not exist, the value is 0. AlternateFuel[2] retrieves the second AlternateFuel/EstimateWeight or AlternateFuel/Duration value within the AlternateFuel list, etc.

FinalReserve can be referenced with a child of Alternate Fuel. “.” dot notation can be used in the variable name to reference this special case.

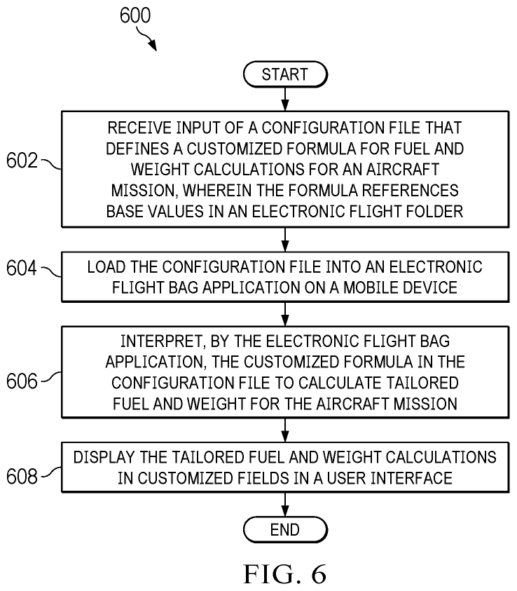

FIG. 6 depicts a flowchart illustrating a process for generating tailored fuel and weight calculations in accordance with an illustrative embodiment. Process 600 can be implemented in tailored fuel calculation system 200 in FIG. 2.

Process 600 begins by receiving input of a configuration file that defines a customized formula for fuel and weight calculations for an aircraft mission, wherein the formula references base category values in an electronic flight folder (step 602). The base category values might conform to ARINC® 633 standards. The configuration file might comprise an extensible markup language (XML) configuration file that provides a syntax that allows users to add clarifying variables to the reference base category values. The configuration file and electronic flight folder can be contained in an electronic flight bag application.

The configuration file is loaded into an electronic flight bag application on a mobile device (step 604).

The electronic flight bag application interprets the customized formula in the configuration file to calculate tailored fuel and weight for the aircraft mission (step 606). The tailored fuel and weight calculations are displayed in customized fields in a user interface (step 608). A notification can also be sent to ground crew personnel to add fuel according to the tailored fuel and weight for the aircraft mission. This notification can be displayed on a similar user interface to the electronic flight bag application or on a different type of user interface specific for the ground crew. Process 600 then ends.

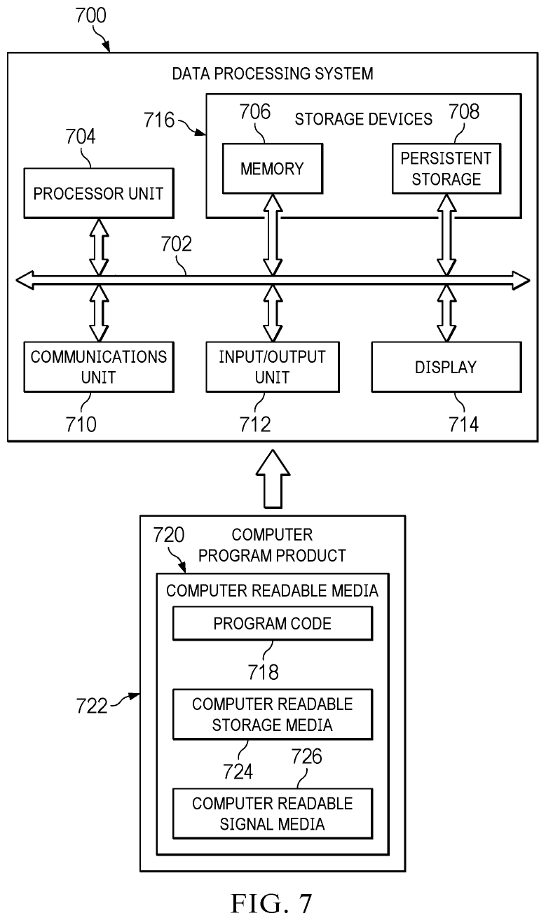

Turning now to FIG. 7, an illustration of a block diagram of a data processing system is depicted in accordance with an illustrative embodiment. Data processing system 700 may be used to implement computer system 250 in FIG. 2. In this illustrative example, data processing system 700 includes communications framework 702, which provides communications between processor unit 704, memory 706, persistent storage 708, communications unit 710, input/output (I/O) unit 712, and display 714. In this example, communications framework 702 takes the form of a bus system.

Processor unit 704 serves to execute instructions for software that may be loaded into memory 706. Processor unit 704 may be a number of processors, a multi-processor core, or some other type of processor, depending on the particular implementation. In an embodiment, processor unit 704 comprises one or more conventional general-purpose central processing units (CPUs). In an alternate embodiment, processor unit 704 comprises one or more graphical processing units (GPUs).

Memory 706 and persistent storage 708 are examples of storage devices 716. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 716 may also be referred to as computer-readable storage devices in these illustrative examples. Memory 706, in these examples, may be, for example, a random access memory or any other suitable volatile or non-volatile storage device. Persistent storage 708 may take various forms, depending on the particular implementation.

For example, persistent storage 708 may contain one or more components or devices. For example, persistent storage 708 may be a hard drive, a flash memory, a rewritable optical disk, a rewritable magnetic tape, or some combination of the above. The media used by persistent storage 708 also may be removable. For example, a removable hard drive may be used for persistent storage 708. Communications unit 710, in these illustrative examples, provides for communications with other data processing systems or devices. In these illustrative examples, communications unit 710 is a network interface card.

Input/output unit 712 allows for input and output of data with other devices that may be connected to data processing system 700. For example, input/output unit 712 may provide a connection for user input through at least one of a keyboard, a mouse, or some other suitable input device. Further, input/output unit 712 may send output to a printer. Display 714 provides a mechanism to display information to a user.

Instructions for at least one of the operating system, applications, or programs may be located in storage devices 716, which are in communication with processor unit 704 through communications framework 702. The processes of the different embodiments may be performed by processor unit 704 using computer-implemented instructions, which may be located in a memory, such as memory 706.

These instructions are referred to as program code, computer-usable program code, or computer-readable program code that may be read and executed by a processor in processor unit 704. The program code in the different embodiments may be embodied on different physical or computer-readable storage media, such as memory 706 or persistent storage 708.

Program code 718 is located in a functional form on computer-readable media 720 that is selectively removable and may be loaded onto or transferred to data processing system 700 for execution by processor unit 704. Program code 718 and computer-readable media 720 form computer program product 722 in these illustrative examples. In one example, computer-readable media 720 may be computer-readable storage media 724 or computer-readable signal media 726.

In these illustrative examples, computer-readable storage media 724 is a physical or tangible storage device used to store program code 718 rather than a medium that propagates or transmits program code 718. Computer readable storage media 724, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 718 may be transferred to data processing system 700 using computer-readable signal media 726. Computer-readable signal media 726 may be, for example, a propagated data signal containing program code 718. For example, computer-readable signal media 726 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 700 are not meant to provide architectural limitations to the manner in which different embodiments may be implemented. The different illustrative embodiments may be implemented in a data processing system including components in addition to or in place of those illustrated for data processing system 700. Other components shown in FIG. 7 can be varied from the illustrative examples shown. The different embodiments may be implemented using any hardware device or system capable of running program code 718.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

As used herein, “a number of” when used with reference to items, means one or more items. For example, “a number of different types of networks” is one or more different types of networks. In illustrative example, a “set of” as used with reference items means one or more items. For example, a set of metrics is one or more of the metrics.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method of generating tailored fuel and weight calculations, the method comprising:
using a number of processors to perform:
receiving input of a configuration file that defines a customized formula for fuel and weight calculations for an aircraft mission, wherein the formula references base category values in an electronic flight folder;
loading the configuration file into an electronic flight bag application on a mobile device; and
interpreting, by the electronic flight bag application, the customized formula in the configuration file to calculate tailored fuel and weight for the aircraft mission.

2. The method of claim 1, wherein the configuration file provides a syntax that allows users to add clarifying variables to the reference base category values.

3. The method of claim 2, wherein the clarifying variables are applied to a number of configuration elements in the configuration file that correspond to the reference base category values.

4. The method of claim 1, wherein the configuration file comprises an extensible markup language (XML) configuration file.

5. The method of claim 1, wherein the electronic flight bag application receives the electronic flight folder from a crew briefing and flight monitoring application.

6. The method of claim 1, wherein the reference base category values conform to ARINC® 633 standards.

7. The method of claim 1, further comprising displaying the tailored fuel and weight calculations in customized fields in a user interface.

8. The method of claim 1, further comprising notifying ground crew personnel to add fuel according to the tailored fuel and weight for the aircraft mission.

9. A system for generating tailored fuel and weight calculations, the system comprising:
a storage device that stores program instructions;
one or more processors operably connected to the storage device and configured to execute the program instructions to cause the system to:
receive input of a configuration file that defines a customized formula for fuel and weight calculations for an aircraft mission, wherein the formula references base category values in an electronic flight folder;
load the configuration file into an electronic flight bag application on a mobile device; and
interpret, by the electronic flight bag application, the customized formula in the configuration file to calculate tailored fuel and weight for the aircraft mission.

10. The system of claim 9, wherein the configuration file provides a syntax that allows users to add clarifying variables to the reference base category values.

11. The system of claim 10, wherein the clarifying variables are applied to a number of configuration elements in the configuration file that correspond to the reference base category values.

12. The system of claim 9, wherein the configuration file comprises an extensible markup language (XML) configuration file.

13. The system of claim 9, wherein the electronic flight bag application receives the electronic flight folder from a crew briefing and flight monitoring application.

14. The system of claim 9, wherein the reference base category values conform to ARINC® 633 standards.

15. The system of claim 9, wherein the processors further execute instructions to display the tailored fuel and weight calculations in customized fields in a user interface.

16. The system of claim 9, wherein the processors further execute instructions to notify ground crew personnel to add fuel according to the tailored fuel and weight for the aircraft mission.

17. A computer program product for generating tailored fuel and weight calculations, the computer program product comprising:
a computer-readable storage medium having program instructions embodied thereon to perform the steps of:
receiving input of a configuration file that defines a customized formula for fuel and weight calculations for an aircraft mission, wherein the formula references base category values in an electronic flight folder;
loading the configuration file into an electronic flight bag application on a mobile device; and interpreting, by the electronic flight bag application, the customized formula in the configuration file to calculate tailored fuel and weight for the aircraft mission.

18. The computer program product of claim 17, wherein the configuration file provides a syntax that allows users to add clarifying variables to the reference base category values.

19. The computer program product of claim 18, wherein the clarifying variables are applied to a number of configuration elements in the configuration file that correspond to the reference base category values.

20. The computer program product of claim 17, wherein the configuration file comprises an extensible markup language (XML) configuration file.

21. The computer program product of claim 17, wherein the electronic flight bag application receives the electronic flight folder from a crew briefing and flight monitoring application.

22. The computer program product of claim 17, further comprising instructions for displaying the tailored fuel and weight calculations in customized fields in a user interface.

23. The computer program product of claim 17, further comprising instructions for notifying ground crew personnel to add fuel according to the tailored fuel and weight for the aircraft mission.
